(19) United States
(12) Patent Application Publication
(10) Pub. No.: US 2002/0080010 A1
(43) Pub. Date: Jun. 27, 2002

(54) Power line communications network device for DC powered computer

(76) Inventor: George Zhang, San Mateo, CA (US)

Correspondence Address: Harris Zimmerman, Law Offices of Harris Zimmerman, 1330 Broadway, Suite 710, Oakland, CA, 94612-2506, US

(21) Appl. No.: 09/854,454

(22) Filed: May 14, 2001

Related U.S. Application Data
(60) Provisional application No. 60/257,554, filed on Dec. 22, 2000.

(51) Int. Cl. H04M 11/04

(52) U.S. Cl. 340/310.06; 340/310.01

(57) ABSTRACT

A multi-point computer networking system for transmitting data over power lines is built into an external AC adapter that powers a computer device or peripheral. The networking system includes a data bus interface unit for exchanging data with a computer, a power line data transceiver unit for placing data onto and taking data off of the power line, and a network controller implementing a network protocol for sending and receiving messages. The networking system is disposed within the housing of the AC adapter. Therefore, there is no extra box or cable needed for each DC powered computer device to serve both DC power and data networking functions.

### REFERENCE TO RELATED APPLICATION

This application claims priority based on Provisional Application No. 60/257,554, filed Dec. 22, 2000.

### BACKGROUND OF THE INVENTION

The present invention relates in general to a computer networking system. More particularly, the present invention is an apparatus for providing a data networking capability to a DC powered computer devices via an AC power line.

A computer network typically includes a number of desktop computers, portable computers (such as laptop computer and notebook computer), printers, peripheral equipment (devices) and other electronic devices with external AC power adapter, such as personal data assistants (PDA), or other internet devices, and the like. These devices are linked together to permit each individual device to exchange data with one or more other devices on the network. Historically, the devices of a computer network have been linked together by dedicated wires. However, dedicated wiring has many drawbacks, such as high cost, inconvenience and installation difficulty, especially when expanding or reconfiguring the network system. Thus other alternative approaches have been developed for network communications media, using wireless connections and AC power lines.

In power line communications (PLC), network data is transmitted on an existing power line along with the electrical AC line current already present for delivering electrical power. Using the power line as the medium for communications is particularly convenient because a power line will always be present to provide AC power to the various devices on a network. A number of PLC protocols (such as: X-10, CEBus, Lonworks and PowerPacket) have been developed, and chip sets employing them are commercially available, making the AC power line a feasible network communications medium.

There are a number of PLC patents issued. For example, U.S. Pat. No. 4,809,296 shows a structure of a PLC system using one kind of modulation scheme. However, it does not show how to implement the scheme as a network device. U.S. Pat. No. 5,684,826 shows how to build a RS-485 power line modem for data networks, but it does not show the application for commercial and personal computer devices. Moreover, RS-485 is an industrial communication scheme that is not suitable for commercial and personal computer applications, and the speed is too slow for computer local area network (LAN) applications such as Ethernet.

There are some PLC products that have been introduced commercially. For example, “PassPort” is built by Intelogis Inc., of Draper, Utah. It is a low speed (350 Kbps) wall plug-in PLC device which requires an external parallel cable to connect to a personal computer. This provides no advantage over a regular LAN system since they both require two separate cables (an AC power cord and a data cable).

### SUMMARY OF THE INVENTION

The present invention generally comprises an apparatus both for providing DC power to a computer device which requires DC operating power, and for providing power line data communications. The PLC networking system is combined within an AC/DC converter module, as is known in the prior art for a DC powered computer device, so that component size is minimized and network connections are simplified. Moreover, the device requires no desk space (“zero footprint”).

Accordingly, several objects and advantages of my present invention are (1) By combining the PLC networking system with an AC adapter, the separate power cord and data cable may be eliminated, thereby requiring only a single main power cord for each networked DC-powered computer device. (2) The PLC networking system is able to obtain DC power from the AC adapter, thereby reducing both the cost and size of the PLC networking system. (3) Combining the PLC networking system with an AC adapter achieves higher system integration, thereby eliminating extra hardware installation by the end user. (4) Because the PLC networking system is built inside an AC adapter and shares the same AC power cord, electromagnetic interference (EMI) noise can be blocked by providing an EMI isolator to improve the quality and throughput of data communications.

### BRIEF DESCRIPTION OF THE DRAWING

FIG. 1A is a functional block diagram depicting a PLC network system for a DC powered computer device and providing separate DC and data connectors.

FIG. 1B is a functional block diagram depicting a PLC network system for a DC powered computer device and providing a combined DC and data bus connector.

FIG. 1C is a perspective view showing the PLC network system connected to a DC powered computer device.

FIG. 2A is a functional block diagram depicting a PLC network system corresponding to the embodiment of FIG. 1A.

FIG. 2B is a functional block diagram depicting a PLC network system corresponding to the embodiment of FIG. 1B.

FIG. 2C is a schematic view of a further embodiment of the cable connector arrangement of the invention.

FIG. 3 is a functional block diagram depicting further details of the PLC network system of the invention.

### DESCRIPTION OF THE PREFERRED EMBODIMENT

The present invention generally comprises a multi-point computer networking system that is built into an external AC adapter for transmitting data over power lines. A significant aspect of the invention is that the networking system shares the housing with the AC adapter, thereby obviating the need for a separate networking box and cable for each DC powered computer device.

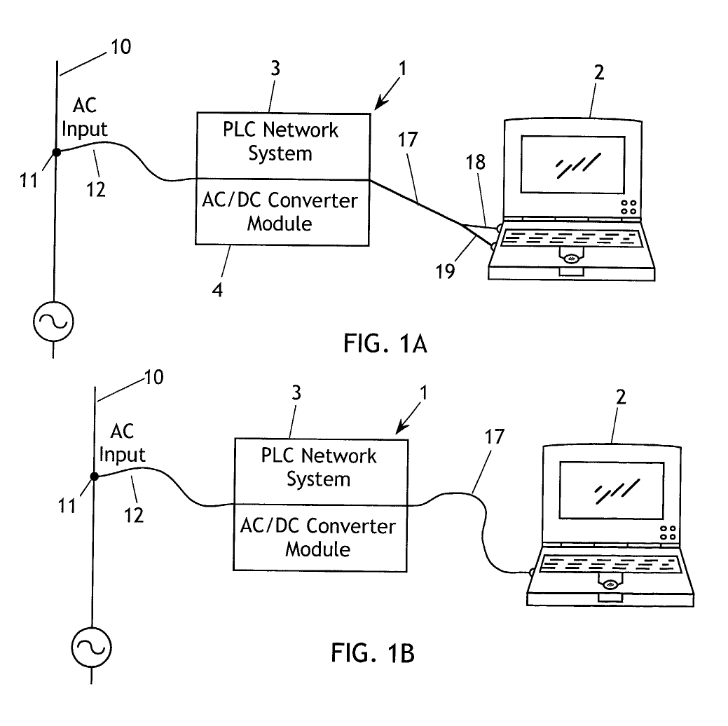

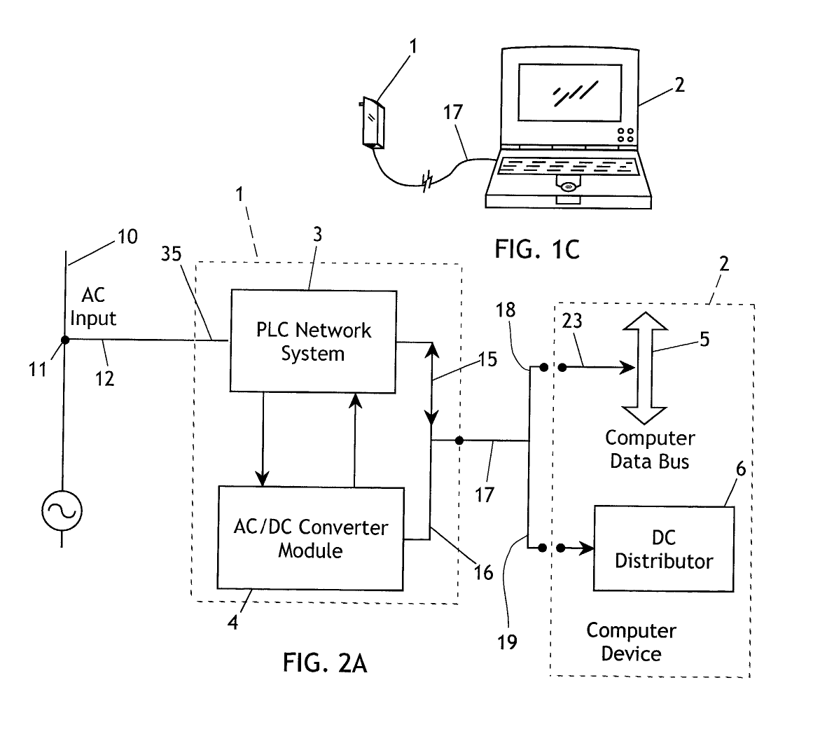

With regard to FIG. 1A and 1C, a PLC network system 3 and an AC/DC converter module 4 are secured within a power-network module 1 to serve a DC powered computer device 2. A power line 10 is commonly found in commercial, industrial or residential buildings. Power line 10 may also be provided, for example, by a system of temporary power lines or extension cords such as might be set up at a trade show or exhibition for supplying electrical power to a number of computers, printers, or other peripheral equipment. PLC network system 3 is connected to power line 10 through an AC power cord 12 and AC power outlet box 11. The PLC network system 3 also connects to a DC powered computer device 2 via a DC/data cable 17 that splits into data cable 18 and DC power cable 19. The data cable 18 is plugged in to a data bus connector in the computer device such as a universal serial bus (USB) connector. The DC cable 19 is plugged in to a DC input socket which is typically provided in such apparatus. Alternative, as shown in FIG. 1B, the cable 17 may carry both DC power and data to an appropriately configured port in the computer device.

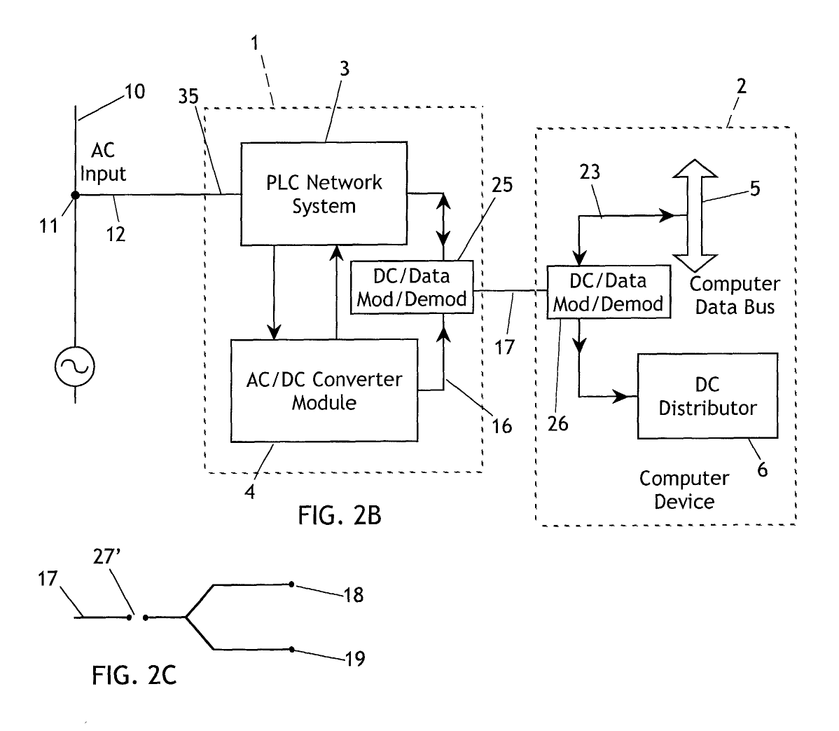

With regard to FIG. 2A, the PLC network system 3 receives AC power and the PLC data signal 35 from AC power cable 12. PLC network system 3 conducts AC power to the AC/DC converter module 4. The AC/DC converter module 4 also provides the operating DC power to the PLC network system 3. A DC/data cable 17 connects the DC output 16 and the network data interface 15 from PLC network system 3 to the DC powered computer device 2. The DC distributor 6 distributes the operating power within the DC powered computer device 2. A computer data bus 5 in the DC powered computer device 2 communicates network data 23 to and from the PLC network system 3 through the DC/data cable 17.

It may be noted that the DC/data cable 17 may include two conductors for DC power, at least two conductors for data communications, and a shield or ground conductor. The cable 17 may bifurcate to a data branch 18 that terminates in an appropriate connector, and a DC power branch 19 that terminates in another connector appropriate for power transmission. With reference to FIG. 2B, a single cord configuration with reduced wire count includes the components shown in FIG. 2A, and, in addition, a DC/data modulator 25 within the module 1 that modulates/demodulates the data onto the DC power wires. The computer device 2 is likewise provided with a DC/data modulator 26 that modulates/demodulates the data onto the DC power wires. This feature reduces the number of wires to a minimum, resulting in a lower cost cable. However, the DC/data modulators 25 and 26 add more cost and complexity to both the PLC network system 3 and to computer device 2.

With reference to FIG. 2C, the cable 17 may be provided with a connector 27′ that is interposed in a medial portion of the cable, with the branches 18 and 19 provided with separate connectors, as described previously. This arrangement permits connection and disconnection to take place. The connector 27′ (or 27) may comprise a universal connector. Other similar connection formats are possible to accommodate various computer device configurations.

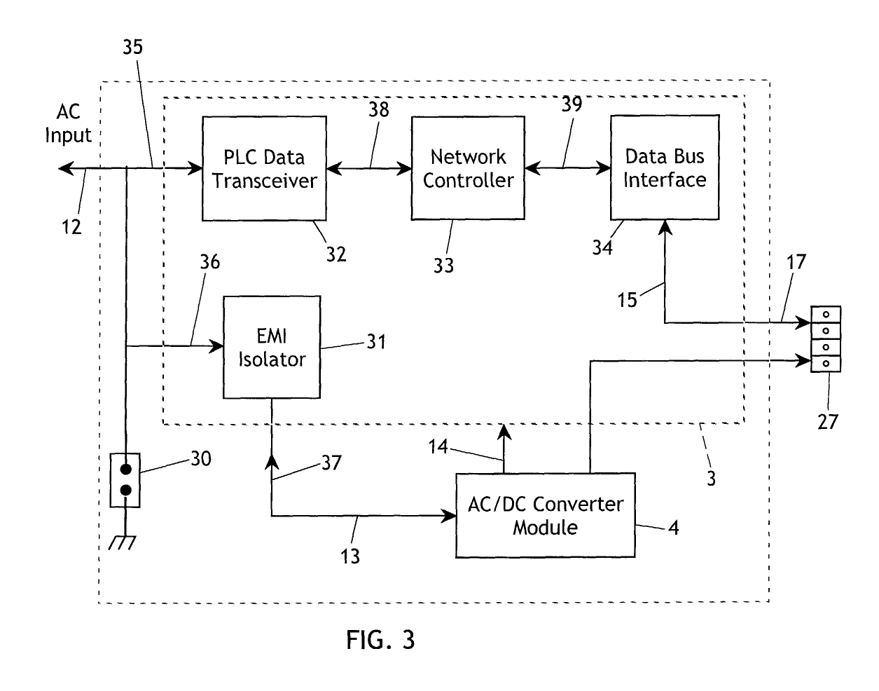

With regard to FIG. 3, the PLC network system 3 may include an EMI isolator 31 interposed between the AC input 13 of the AC/DC converter module 4 and the AC plug input 12. The particular manner in which the power line data transceiver 32 is connected to the power line is important because the PLC signal 35 on the power line is transferred through the same power cable shared with the AC/DC converter module 4. The AC/DC converter module 4 may generate significant high frequency electromagnetic interference (EMI) noise 37, especially inside a computer enclosure, and the EMI noise 37 may transfer to the AC power input and thence to the PLC data transceiver 32. The frequency range of the EMI noise 37 is typically from several kilohertz to several megahertz. It may interfere with the PLC signal, especially in high speed PLC systems. The result may be distortion of the PLC signal, causing a high bit-error-rate (BER), a slowdown of data throughput, and possibly a jam of the communication channel (which is the power line). Generally, the EMI isolator 31 is a typical LC low-pass filter. The EMI isolator 31 is designed to block signals higher than 500 Hz. Also a surge protector 30 is added to the AC input line to protect internal electrical circuitry from power line surges.

The PLC data transceiver 32 transmits and receives the PLC signal 35. Since there are many commercial power line data transceivers modules available from multiple vendors, the structures, circuitry and principles are well known and thus need not be described in detail here.

A 32 bit RISC microcontroller is used to implement both the network controller 33 and data bus interface 34. Network controller 33 is a part of the RISC microcontroller functions. The network controller 33 is responsible for implementing the network protocols for sending and receiving messages via a computer network. Data bus interface 34 also is a part of the RISC microcontroller functions. The RISC microcontroller may have two universal synchronous/asynchronous receiver/transmitter (USART) ports. A software module simulates the function of universal serial bus (USB) port (or the equivalent) through one of the USART ports. The simulated USB port is directly connected to the computer data bus in the DC powered computer device 2 through a USB data cable.

### Preferred Embodiment—Operation

The PLC network system 3 performs the networking function that covers the OSI seven-layer model from layer 1 to layer 4. The PLC data transceiver 32 handles layer 1, physical layer function. The network controller 33 handles layer 2, the link layer; layer 3, the network layer; and layer 4, the transport layer. The network controller 33 performs data link control, such as framing, data transparency, error control, network routing, addressing, call setup/clearing, and end-to-end message transfer such as connection management, error control, fragmentation, flow control, etc.

When the DC powered computer device 2 has a network data packet which need be sent to other networked devices, it puts the network data 23 on the computer data bus 5 and then transfer it to the data bus interface 34 via data cable 18, and DC/data cable 17. The data bus interface 34 buffers the data packet 39 and transfers it to the network controller 33. The network controller 33 assembles the necessary overhead of networking control bits to the body of the data packet. Then the data packet is modulated to digital signal 38 by the RISC microcontroller. The PLC data transceiver 32 takes the modulated digital signal 38 and converts it to a PLC signal 35. Finally, the PLC signal 35 is placed onto the power line 10.

In the opposite direction, the AC power signal 36 passes through the EMI isolator 31 to the AC/DC converter 4, which provides power to the PLC network 3 through line 14 and to the computer device through connector 27. When the PLC data transceiver 32 receives a PLC signal 35 from power line 10, it sends the digital signal 38 to the network controller 33. The digital signal 38 is demodulated by the RISC microcontroller which also de-assembles the networking control bits by network controller 33. Then the data packet 39 goes through the data bus interface 34 and is transferred to the computer data bus 5.

### Conclusion, Ramifications, and Scope

Accordingly, it can be seen that the PLC network system of this invention can be used for portable computers and other electronic devices which employ external AC power adapters (such as a personal data assistant (PDA), or other internet devices, etc.) to provide computer networking via power lines. The PLC network system is embedded in an AC power adapter enclosure, so that it is able to share a single main power cord for both DC power input as well as exchanging data with other devices on a computer network. Because the PLC network system does not require an extra data cable, the networking installation is very simple.

The embedded PLC network system has additional advantages in that:

It reduces cost and size by eliminating the external data cable and by using DC power from the AC/DC converter module in a same enclosure as its operation power source. It does not require its own power supply, nor does it draw DC current from its connected computer device.

It reduces the noise level at the PLC data transceiver side due to the EMI filter blocking the noise from the switched power supply.

It provides a highly integration, no new wires solution for networking by offering no additional installation other than plugging in a DC power cable.

By being disposed in the AC adapter module and attaching directly to the computer via the computer power input cable, the PLC network device does not occupy any horizontal desk space ( a “zero footprint” factor), and the short cable minimizes entanglement with other computer cables or wires

Although the description above contains many specifics, these should not be construed as limiting the scope of the invention but as merely providing illustrations of some of the presently preferred embodiments of this invention. For example, (1) the data bus interface will support any other kind of buses, such as ISA bus, PCI bus, IDE bus, SCSI bus, etc. It also will support other kinds of communication ports, such as any parallel port or any serial port. It also can be a special type of bus that directly connects to a data communication chipset on the computer motherboard or a plug-in PC card, such as a PCMCIA card. (2) The electronic circuitry of the PLC network system can physically be installed internally in the computer device and in the AC/DC power module, or as an attachment to an AC/DC converter module enclosure.

Thus the scope of the invention should be determined by the appended claims and their legal equivalents, rather than by the examples given.

1. A power line communication network device, including:
power line communication data transceiver means for transmitting and receiving computer system data over an AC power line;
a housing for enclosing said data transceiver means;
an AC/DC converter module within said housing for providing DC power to said data transceiver means and to a computer device;
means for connecting said AC/DC converter module to an AC power line;
means for connecting to a DC power input port of a computer device and transmitting DC power to said computer device; and,
means for transmitting and receiving computer system data between said data transceiver means and the computer device.

2. The power line communication network device of claim 1, further including a cable both for transmitting DC power to said computer device and for transmitting and receiving computer system data between said data transceiver means and the computer device.

3. The power line communication network device of claim 2, wherein said cable includes at least one DC conductor, and further including modulator/demodulator means connected to said data transceiver means for transmitting said computer system data on said at least one DC conductor.

4. The power line communication network device of claim 2, wherein said cable includes at least one conductor for transmitting said computer system data.

5. The power line communication network device of claim 1, wherein said means for connecting said AC/DC converter module to an AC power line includes a plug connector adapted to engage a power plug receptacle.

6. The power line communication network device of claim 5, wherein said plug connector further supports said housing in depending relationship from the plug receptacle.

7. The power line communication network device of claim 1, further including electromagnetic interference isolator means connected between said AC/DC converter module and said AC power line.

8. The power line communication network device of claim 7, wherein said EMI isolator is adapted to filter out electromagnetic noise emanating said AC/DC converter module.

9. The power line communication network device of claim 2, further including a single connector for conducting DC power and system data to the computer device.

10. The power line communication network device of claim 2, wherein said cable includes a bifurcated portion defining a DC power branch and a data branch, and connection means for joining said branches to the computer device.

11. The power line communication network device of claim 10, wherein said DC power branch includes a connector adapted to engage the DC input port of the computer device.

12. The power line communication network device of claim 10, wherein said data branch includes a connector adapted to engage a data input port of the computer device.

13. The power line communication network device of claim 10, wherein said cable includes a medial portion, and a male/female connector pair interposed in said medial portion.

14. The power line communication network device of claim 2, wherein said cable includes a medial portion, and a male/female connector pair interposed in said medial portion.
